(19) United States
(12) Patent Application Publication
(10) Pub. No.: US 2008/0034396 A1
(43) Pub. Date: Feb. 7, 2008

(54) SYSTEM AND METHOD FOR VIDEO DISTRIBUTION AND BILLING

(76) Inventor: Zvi Haim LEV, Tel Aviv (IL)

Correspondence Address: SUGHRUE MION, PLLC, 2100 PENNSYLVANIA AVENUE, N.W., SUITE 800, WASHINGTON, DC, 20037, US

(21) Appl. No.: 11/754,949

(22) Filed: May 29, 2007

Related U.S. Application Data
(60) Provisional application No. 60/808,953, filed on May 30, 2006.

(51) Int. Cl. H04N 7/173

(52) U.S. Cl. 725/118

(57) ABSTRACT

A system for distribution of video and audio data, the system including a wireless device operating in a wireless network, a protocol stack, a dispatcher of video and audio data, a storage server, and a video encoder. Multiple methods for using video and audio data, including, among others, methods for optimizing use of mobile radio bandwidth, optimizing use of technical limitations in wireless devices, for allowing users to use premium SMS to interact with the data distribution system, and for verifying the status of a user.

### CROSS REFERENCE TO RELATED APPLICATION

This application claims the benefit of U.S. Provisional Patent Application Ser. No. 60/808,953, filed on May 30, 2006, entitled “System and Method for Video Distribution and Billing”, which is incorporated herein by reference in its entirety.

### BACKGROUND OF THE EXEMPLARY EMBODIMENTS OF THE INVENTION

1. Field of the Exemplary Embodiments of the Invention

The present invention relates generally to the field of video distribution and video sharing. Furthermore, this invention is for a system and method that utilize present day video call capable equipment and encoding/decoding capabilities in order to provide better visual representation of the data.

The embodiments described herein are illustrative and non-limiting. Definitions are provided solely to assist one of ordinary skill in the art to better understand these illustrative, non-limiting embodiments. As such, these definitions should not be used to limit the scope of the claims more narrowly than the plain and ordinary meaning of the terms recited in the claims. With that caveat, the following definitions apply:

“Coder” means a block that transforms video stream into an encoded video stream of typically smaller size in bits than the original video stream.

“Computational facility” means any computer, combination of computers, or other equipment performing computations, that can process the information sent by an imaging device. Prime examples would be the local processor in the imaging device, a remote server, or a combination of the local processor and the remote server.

“Displayed” or “printed”, when used in conjunction with an imaged document, is used expansively to mean that the document to be imaged is captured on a physical substance (as by, for example, the impression of ink on a paper or a paper-like substance, or by embossing on plastic or metal), or is captured on a display device (such as LED displays, LCD displays, CRTs, plasma displays, ATM displays, meter reading equipment or cell phone displays).

“Image” means any image or multiplicity of images of a specific object, including, for example, a digital picture, a video clip, or a series of images.

“Macroblock” means a fixed-size block, typically 16 pixels×16 pixels, that undergoes frequency domain compression and motion estimation manipulation as defined in H263, MPEG4, or other applicable video compression standards.

“Server” means any computer, combination of computers, or other equipment performing computations, that can process digital audio and video information. Prime examples would be the local processor in a wireless terminal, a PC, a server, or a combination of several servers.

“Synthetic graphics” means generic content that is audio, or visual, or audio and visual, which is displayed in conjunction with and as part of an audiovisual clip, and which in a particular display could include, without limitation, charts, tables, graphs, figures, text, and video games.

“User” typically refers to the video-telephony device user. The video-telephony device user may be a human user, or may be an automatic or semi-automatic system, such as a security system which may be fully automated or which may have human involvement.

“Video” means a sequence of frames or images with some synchronization data.

“Video call” means two-way and one-way video calls performed via any communication link, e.g., computers with web-cams, mobile phones, any imaging/display device with video streaming capability, and/or servers. The video call may be performed from a user to a computational facility, after which the computational facility may take action according to the video data.

“Video data” is any data that can be encapsulated in a video format, such as a series of images, streaming video, video presentation, or film. Video data includes specifically data which is only visual, data which is only audio, and data which is both audio and visual.

“Video telephony” or “Voice over IP (VOIP) session” means any session where audio and video streams are exchanged between two video enabled endpoints according to some video communication protocol. Examples of such protocols are H.324M (in 3G UMTS networks), H.323 (in wire line networks), SIP/IMS, and the Nokia video sharing protocol.

“Video-telephony device” means any equipment capable of holding a video telephony session, including, for example, 3G videophones, a PC with a webcam, or a fixed line videophone.

2. Description of the Related Art

Video distribution and video sharing is a highly successful usage model of the Internet. Some prominent existing examples of video distribution and sharing methods are:

Video distribution method 1: Video portal of professionally created content. One embodiment of such a portal is a website with a specifically labeled and organized selection of commercial quality content, e.g., movies, TV shows, documentaries, or music video clips. Viewers can connect and watch, either for free or for a fee, the video content, either through a personal computer or through a mobile phone with video streaming capabilities. Examples of such web sites include news websites (e.g., CNN.com), movie websites, adult content websites, and video portals of major service providers and telecom providers (e.g., Vodafone Live, or the Orange portal).

Video distribution method 2: Video sharing portals. These websites feature content which is uploaded by users either for a fee or for free. Content organization, labeling, and rating, are typically done by the users themselves or by a voting system. Content selection, such as approval of content for display, or removal of offensive or copyright-infringing material, is typically done by the web-site managers based on viewing the clips and/or based on viewer reports. Viewers can connect and watch the video content either for free or for a fee, either through a personal computer or through a mobile phone with video streaming capabilities. Examples of such websites include youtube.com, and metacafe.com.

Both types of video portals described above typically enable content viewing, download of data, and upload of data, as well as video clip “sharing” where a user can send an email/SMS to a friend which would redirect the receiver of the message (that is, the friend who receives the email/SMS) to the same video portal for viewing the same clip watched by the sender.

While highly successful, existing systems have some shortcomings when they are used with mobile devices on present day cellular networks:

Existent systems shortcoming 1: Much of the existing video content available on Internet/broadband enabled sites is not suitable for the mobile medium. The screen size, frame rate, audio quality limitations, and video quality limitations, set by the wireless networks and/or by the mobile device, make these videos unattractive and/or hard to follow when played on a mobile device. It is to be stressed that these effects do not prevent the actual playback of the content on the device, but they make playback of low or no value to the spectator.

Existent systems shortcoming 2: Video streaming protocols, such as RTP/RTSP, dictate the utilization of IP communications where several simultaneous data links are realized using different TCP/IP ports. Typically, a cellular carrier would block the ports related to IP-based streaming for external content providers, hence making it impossible for a non-carrier entity to stream video from its own servers. Alternatively, the carrier would not block IP streaming from non-carrier sources, but would price the data packets arriving via this route differently than those arriving from other sources.

In recent years, some newer services have been introduced which use the video calling function of UMTS networks to provide video content via a video call. Such services, offered for example by some carriers and video brokers in the UK, are based on the following mechanisms: Video transmission through video calls, billing through premium rates, and automatic video adaptation. These are now explained more fully:

Video Transmission Through Video Calls: The audio/video content is transmitted as a Video Call (as defined, e.g., in the 3G H.324M standard, and in the emerging IMS over 3G standard). The user makes a video call to a phone number or shortcode, and from that moment on the content is consumed by the user for the duration of the call.

Billing Through Premium Rates: User is charged per duration of the call (often per minute) via “premium” call” rates, that is, the call carries a higher cost per minute than a normal video call would, thus providing revenue for the carrier, for the billing provider, and for the content and/or service provider. It should be noted that even if the call is priced as a standard video call, the content/service provider may receive a share of the revenue collected by the carrier.

Automatic Video Adaptation: Available video content is not typically based on the codecs supported by video calls, and/or is not in the proper format and of the proper bandwidth. Hence, it is necessary to convert the video feeds (whether such feeds are pre-recorded or live) to the limitations of the cellular network.

These newer services introduce the following issues:

Video Transmission to Many Users: The video call protocol implies a one-to-one connection between endpoints with specific phone numbers (or specific MSISDN numbers). At the same time, a truly commercial service would need to handle many simultaneous calls to the same number. Thus, current video call based services must resort to a special routing mechanism supplied by carriers or by special purpose video gateways. This implies that special numbers/routing services must be purchased from the carrier or gateway operators at considerable expense. Another problem with the video call mechanism is that many users do not know how to execute a video call.

Billing: Premium charging for interactive voice response (“IVR”), while convenient, requires some precautions in live use. For example, the user has to be notified in advance of the price per minute, prices per minute have an upper cap, and often users feel frustrated and cheated by the high price of a call. Furthermore, since video calls are considered new and advanced services, users may be wary of making a video call with no pre-guarantee of the total price. It should also be noted that the process of achieving a revenue share deal for premium IVR calls with the carrier may be, for a content provider, a lengthy and undesirable process.

Video Adaptation: Present day video content services are based on video-gateways which adapt content on-the-fly—that is, the video is streamed live either from a streaming server, or from a live camera capture card, or from some other interface, to a Video Gateway. Such Video Gateway products are produced by, e.g., Radvision™, Tandberg™, MX-Telecom™, and others. The video gateway provides on-the-fly media transcoding, bit rate and frame size adaptation. One disadvantage of this method is that due to the need to transcode on-the-fly and completely automatically, many better encoding and editing methods are excluded from the media adaptation process.

### SUMMARY OF EXEMPLARY EMBODIMENTS OF THE INVENTION

The exemplary embodiments of the present invention provide an alternative system and methods for users of the above mentioned video telephony services that are superior to solutions provided by the prior art. The exemplary embodiments of the invention provide a new billing and registration mechanism based on premium SMS. The exemplary embodiments of the invention also provide new video encoding and processing technologies which make video content more viewable and more attractive to users under the severe constraints of a video call.

The billing mechanism is based on having the user send a premium SMS to a specific shortcode number. The response SMS sent back to the user contains the full number to video call. When the user makes the video call, the Caller Line Identification (CLI) mechanism is used to determine the user's entitlement to the service, and potentially also to determine which content to serve to the user, based on the user's past consumption and based also on the particular limitations of the user's specific calling device. The number sent to the user can also serve to load-balance the incoming calls, since different numbers can be provided to different users.

The video encoding described in the exemplary embodiments of the invention is specially adapted to provide an optimal viewing experience. It employs special processing on the video streams, which include audiovisual time expansion/dilation, content based audio adaptation, and smart I-frame/P-frame selection. Furthermore, different versions of the same video might be created, optimized for different calling devices. For example, a calling device which supports the MPEG-4 video codec would receive content utilizing MPEG-4 code, while a device providing only the more basic H.263 video codec calling the same number would receive a video stream encoded in H.263.

### BRIEF DESCRIPTION OF THE DRAWINGS

Various other objects, features and attendant advantages of the exemplary embodiments of the present invention will become fully appreciated as the same become better understood when considered in conjunction with the accompanying detailed description, the appended claims, and the accompanying drawings, in which:

FIG. 1 presents a typical architecture of a related art system based on an Internet connection, a video gateway, and a premium-rate charging mechanism.

FIG. 2 shows a typical embodiment of a related art encoding system

FIG. 3 shows a typical embodiment of a related art coding control method.

FIG. 4 presents an exemplary embodiment of the architecture of the present system.

FIG. 5 presents an exemplary embodiment of a method for using architecture of the present system.

FIG. 6 shows an exemplary embodiment of an encoding system presented in this invention.

FIG. 7 shows an exemplary embodiment of a coding control method presented in this invention.

FIG. 8 illustrates an exemplary embodiment of video layout in this invention.

FIG. 9 illustrates an exemplary embodiment of a method for using a pre-defined quantization map for frames derived with human/automated input for I-frames.

FIG. 10 illustrates an exemplary embodiment of a method for constraining I frame size, determining exact location for the I-frames and macroblock refresh, and doing the refresh of macroblocks based on importance measure.

FIG. 11 illustrates an exemplary embodiment of a method for determining quantization level using a priori knowledge, using special quantization for parts with text, and constraining motion vectors using a priori knowledge.

FIG. 12 illustrates an exemplary embodiment of a method of executing a fade-in and fade-out scenario.

FIG. 13 illustrates an exemplary embodiment of a method for executing a medium motion scenario.

FIG. 14 illustrates an exemplary embodiment of a method for effecting audiovisual time expansion.

FIG. 15 illustrates an exemplary embodiment of a method for processing voice over music.

FIG. 16 illustrates an exemplary embodiment for a new method of billing.

### DETAILED DESCRIPTION OF THE EXEMPLARY EMBODIMENTS

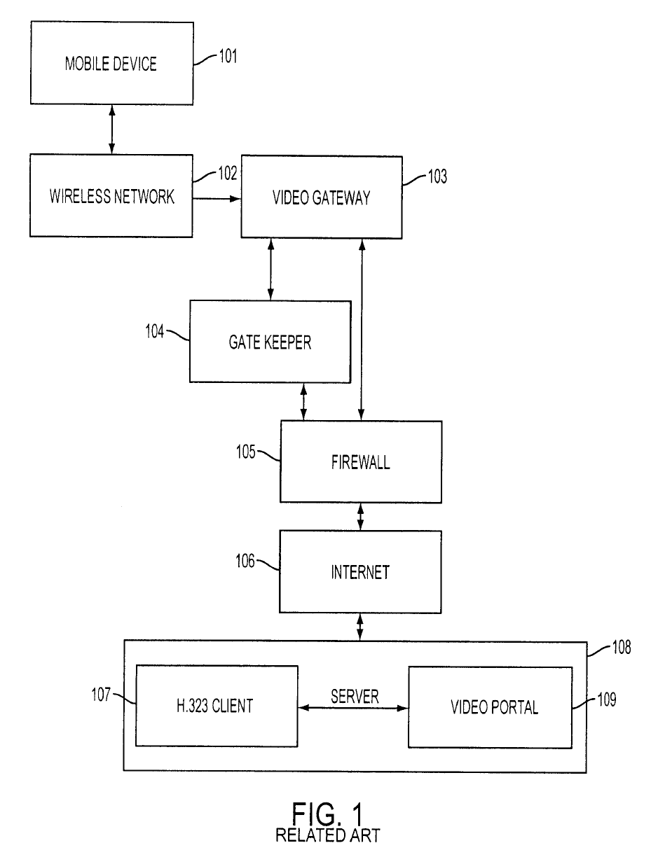

FIG. 1 illustrates a related art system based on an Internet connection, a video gateway, and a premium-rate charging mechanism.

Element 101: The mobile device 101 is engaged in a video telephony session with the wireless network 102.

Element 102: The wireless network 102 provides directly or through a third party a video gateway 103 and a gate keeper 104.

Element 103: The video gateway 103 converts the H.324M or other wireless video telephony protocol into the Internet based H.323 or SIP protocols, and the data packets are routed through the network operator's firewall 105.

Element 104: This is system gate keeper 104. It should be noted that the server 108 has had to pre-register at the gate keeper 104 in order to acquire a routable number that mobile devices such as 101 can call.

Element 105: The data packets from firewall 105 are routed through the Internet 106 to the video service provider's server 108.

Element 106: The Internet 106 connectivity between the server 108 and the firewall 105 can be implemented using any chosen IP, connection including ADSL, E1/T1, ISDN, etc.

Element 107: In this server, the H.323 client 107 (or SIP client) handles the video call protocol, and transmits/receives the video and audio content to the video portal system 109.

Element 108: The server 108 does not possess by itself any phone number belonging to any network. If the session is initiated by the user of the mobile device 101, this user will dial the number registered in the gate keeper 104 in order to reach the server 108.

Element 109: Video portal system 109 handles the audiovisual data stream.

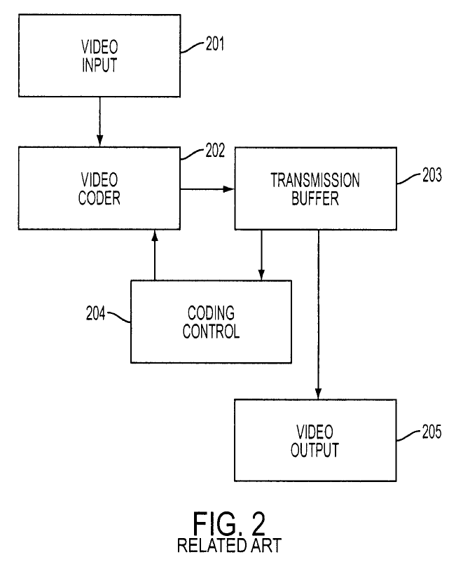

FIG. 2 shows a typical embodiment of a related art encoding system. The related art encoding system consists of the following elements:

Element 201: Video input 201 is a video data stream from a camera or a file. This uncompressed video stream is the input for the video coder 202.

Element 202: Video coder 202 is a unit that performs motion estimation and coding of I and P frames based on the coding quality input from coding control 204. The coded video stream is sent to transmission buffer 203.

Element 203: Transmission buffer 203 is used to store the encoded data for transmission.

Element 204: Coding control unit 204 reads the buffer 203 filling status, sets the coding quality/bitrate allocation and selects whether I or P-frame is transmitted to the video coder 202.

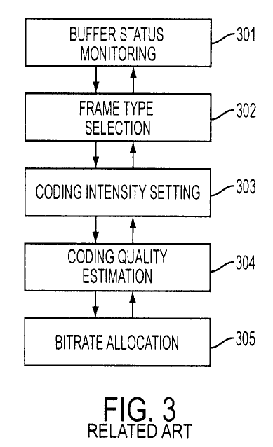

Element 205: Video output 205 uses the coded video stream stored in 203 for transmission. The actual bitrate and quality of the encoded video hence depend on the unit for coding control 204. Element 204 ensures that buffer overflow does not occur (which would result, if it happened, in delayed video at the user terminal), and ensures also that the bandwidth available for video transmission is utilized to the fullest extent possible. The elements and methods typically executed in the coding control unit 204 are presented in FIG. 3. These elements are typically present in most modern video encoders used for constrained bit-rate channels.

FIG. 3 includes:

Element 301: Buffer status monitoring element 301 is based on estimation of the fullness of the transmission buffer 203. If the transmission buffer 203 is relatively full, the coding will be strong, so that the bitrate and image quality will decrease. If the buffer 203 is relatively empty, the coding will be weak, so that the bitrate and image quality will increase.

Element 302: Frame type selection 302 allows a decision whether I or P frame will be transmitted. Typically the decision is based on multiple penalty factors, such as:

1. The amount of time that has passed since the last I-frame has been sent.

2. The changes in the video scene from the last frame.

3. The filling factor of the transmission buffer 203, since the I-frame takes significantly more bits to encode than P-frames.

Element 303: Coding intensity setting 303 allows selection of the intensity of the coding process in video coder 202, based on transmission buffer 203 status, frame type selection 302, and coding quality estimation 304. Thus, frame selection in 302 is partially determined by the coding intensity settings, and at the same time may affect the coding intensity settings. For example, if an I frame has been chosen, the coding intensity applied will be appropriate for an I frame. At the same time, if the generic encoding settings imply that an I frame is not within the bitrate budget at this point, then element 303 will indicate that to element 302.

Element 304: Coding quality estimation 304 allows estimating the image degradation resulting from coding using the coding settings parameters calculated in 303. The video coding estimation takes into account the current video encoding settings determined by 303, but may also change those settings if it determines that the actual encoding quality (judged by the accumulated video error between the encoded and the original uncompressed frame) is too low or too high.

Element 305: Bitrate allocation 305 determines the available bitrate based on the coding parameter, buffer status and coding quality as computed by elements 301, 302, 303, and 304. This allocation is required, because in a live transmission situation, the system cannot delay the transmission of video frames by more than a few frames. Any greater delay would result in a delay noticeable to the user. Hence, the system must estimate the bandwidth requirements and availability in advance.

The method depicted in FIG. 3 can be used with an iterative process called dynamic programming. In advanced coding systems, there is a given allowed delay budget. Based on this delay budget, the coding control 204 calculates the result of various possible allocations of several frames, and selects the encoding strategy for best use of the bitrate budget over a fixed sequence of frames.

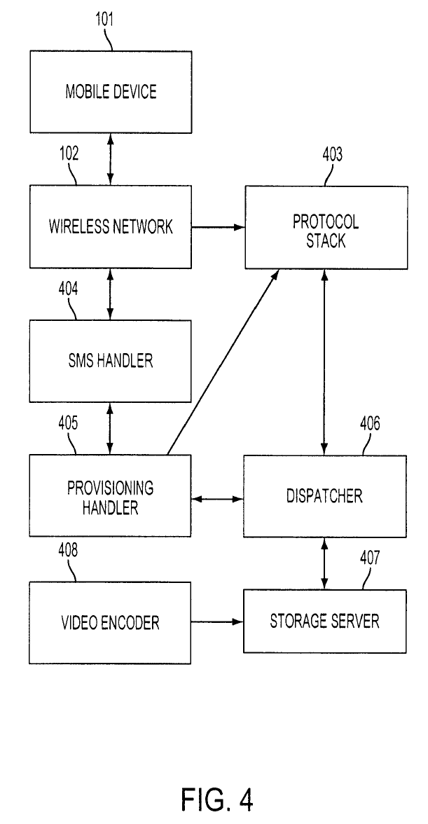

FIG. 4 illustrates one exemplary embodiment of the present invention system.

Element 101 is analogous to element 101 in FIG. 1.

Element 102 is analogous to element 102 in FIG. 1.

Element 403: The video call data coming to or from 102 requires a protocol stack 403 to interpret it. Providers of such a protocol stack 403 include France Telecom™, Tandberg™, Dylogic™, Radvision™ and Dilithium Networks™. The video call packets are routed between 102 and 403 through a point to point data connection, and thus typically do not require firewall protection.

Since a video call point-to-point communication mode is used, the call is not limited to the generic TCP/IP infrastructure of the Internet. For the duration of the video call, the bandwidth for the call is allocated and maintained constant by the network service provider, by means of a circuit-switched video call. This is in contrast to IP based video-streaming as used on the Internet, where the bandwidth is not guaranteed, and where the IP endpoints are typically accessible over the Internet to other clients and to potential security threats. Thus, the video call point-to-point communication mode does not require the typical IP protection schemes (e.g. a firewall) used in standard corporate IP connections. This in turn means that traditional IP security practices often employed by network providers, such as blocking specific IP ports and/or IP addresses, are not required in one exemplary embodiment of the present invention.

Element 404: The SMS handler 404 is a software component that interacts with the carrier's SMSCs either directly or through a service broker. SMS handler 404 can receive an SMS to a designated shortcode/mobile number, and send an SMS to other mobile terminals. Element 404 sends and receives SMS messages to and from the wireless network 102. It can update the provisioning handler about new registered users who have sent an incoming premium SMS, and can get instructions from the provisioning handler to inform users of their account status (that is, the account has been activated, the account is about to expire, etc.). Element 404 supports the sending and receiving of SMS information for subscription, payment, opting in/out of services, and the sending of SMS for approval, billing, notifications and promotions, etc. Element 404 is not mandatory, and the exemplary system can be used without this component when no SMS services are required.

Element 405: The provisioning handler 405 maintains the list of users eligible for video services, and typically also maintains users' MSISDN numbers and billing status. The provisioning handler 405 may also interface with external providers supplying credit card lists or other allowed lists. Element 405 can process incoming MO premium SMS messages, send MT messages, and impact the video call using the billing logic. Element 405 leverages the wireless network's ability to reliably detect and report the MSISDN number of a user when the user makes a video call and/or sends an SMS. This is in contrast to, e.g., WAP browsing, where the MSISDN of the browsing user is not necessarily provided to the server the user is accessing. For example, the provisioning handler 405 can make a warning message appear on the video call through the dispatcher 406, or close a video call session altogether via the control of the protocol stacks 403. The provisioning handler 405 contains new and improved load balancing mechanisms. This could also be called “call balancing”. The callback phone number provided to a user may be different to different users. This way, different users can be directed to different servers, thereby achieving server-controlled load balancing with no additional hardware. Element 405 thus handles all the services related to provisioning, and is not a mandatory part of the system in all scenarios. For example, imagine a system used for displaying generic promotional video content (e.g. advertisements) for users. Any user making a video call would be allowed access to the system for as long as the user wishes to maintain the call—thus element 405 would not be used. Furthermore, if no SMS messages are to be sent to the users, element 404 would also not be required for such a system.

Element 406: The packet dispatcher 406 sends the packets of the audio visual content to the protocol stack 403. The dispatcher 406 may create the packets on the fly, or may use pre-packetized content which can thus be further optimized to utilize the video call bandwidth and the specific type of content sent. For example, audio and video packets may be interleaved in optimal manners to ensure audiovisual synchronization. The dispatcher 406 also decides which version of the video clip to play to the user based on the handset information provided by the H.324M protocol stack.

Element 407: Storage server 407 is used to store several versions of audiovisual data, optimized, off-line, for different handsets. The storage server 407 allows device based encoding. Since different handsets may support different bit rates, audio/video formats and codecs, the exemplary embodiments of the present invention allows for many differently encoded versions of the same clip to reside on the storage server so that when a video call is made, the clip version appropriate for the target device will be displayed. The type of the handset/endpoint consuming the video call can be easily determined by the server from the H.245 protocol which is part of the video call protocol in the 3G H.324M standard, and from a similar mechanism in the IMS/SIP standard. It should be noted that element 407 can be used as a temporary storage (e.g., in-memory storage of encoded real time video prior to its sending to the device).

Element 408: The video encoder 408 employs the previously described optimal encoding methods with or without human intervention and guidance, and stores the pre-prepared content clips on the storage server 407.

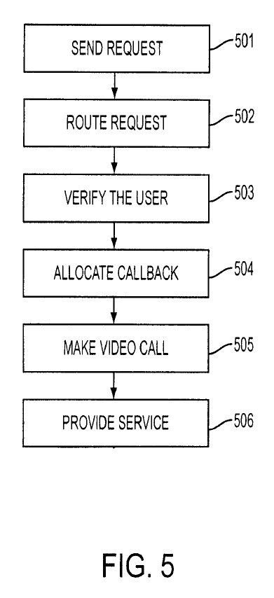

In one exemplary embodiment of the invention, time based premium SMS billing, the method of using the system depicted in FIG. 4, would be the following, as depicted in FIG. 5:

Step 1: Send request 501. The user sends an MO (mobile operator) premium SMS from the mobile device 101 through the wireless network 102.

Step 2: Route request 502. The network routes the SMS based on the target number to the SMS handler 404, which passes the message along with the originating MSISDN of mobile device 101 to the provisioning handler 405.

Step 3: User verification 503. The provisioning handler 405 updates the time allocation table for that user (or creates a new entry if it is a new user). The provisioning handler 405 may also verify the user's personal details if they are relevant. For example, by comparing the device's MSISDN to some database that cross-references to users, the provisioning handler 405 can determine if the user is of proper age to access an adult service. As another example, the provisioning handler may be able to determine based on the MSISDN the user's account status and if the user is a prepaid or postpaid customer.

Step 4: Allocate callback 504. The provisioning handler 405 then allocates a phone number to that user, and sends back to the user's device 101 an MT SMS with the number to call, and/or with other instructions or information.

Step 5: Make video call 505. The user makes a video call from mobile device 101, which is directed to protocol stack 403 via the wireless network 102 based on the number the user has called.

Step 6: Provide service 506. The information about the user's number is used by the provisioning handler 405 to determine eligibility for the service, and by the dispatcher 406 to determine which content stream to retrieve from the storage server 407. For example, if a user is known to have watched a certain video clip in the past, the video clip may not be shown to the user in the current session. (Or the converse could be true. That is, the user could specify that he wants to see that same video clip on a default basis, and the video clip will then be shown whenever the user requests that service.) As another example, if the user has had his participation in a video session interrupted, then when the user accesses that service again, the session can be continued from the exact point of interruption. As another example, specific user information, such as high scores in games, or a user's on-line identity, may be retrieved based on the caller's user number. The process of dispatching the audiovisual packets then goes on until the user terminates the call, or until the provisioning server determines that the user has exceeded the time he/she have paid for. Alternatively, the provisioning server may send MT premium SMS messages to the user during the call to bill for the user's continued content consumption.

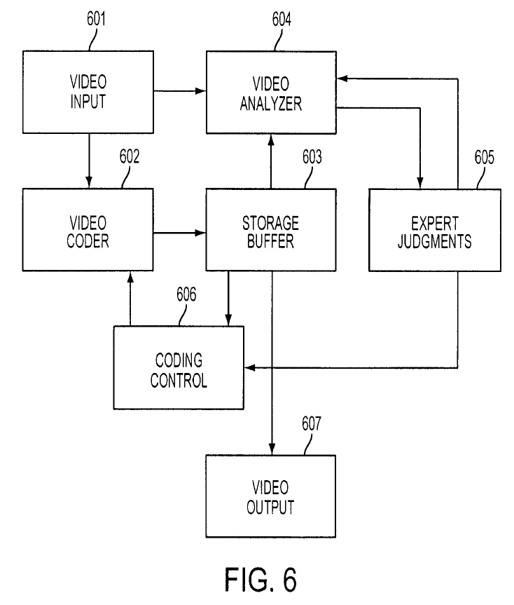

One exemplary embodiment of the encoding system presented in this invention is illustrated on FIG. 6. FIG. 6 includes the following elements:

Element 601: Video input 601 is a video data stream from a camera or a file. The exemplary embodiments of the present invention allows for presence of synthetic information in the video stream, such as text, subtitles, game animation, etc.

Element 602: Video coder 602 is a unit that performs motion estimation and coding of I and P frames based on the coding quality input from coding control 204. Video coder 602 is similar to 202, except that in 602 the coding parameters are changed per macroblock, rather than per frame as in 202.

Element 603: Storage buffer 603 allows storage of the full encoded video in various representations.

Element 604: Video analyzer unit 604 analyzes the video sequence. Possible outputs of 604 include video segmentation, scene change detection, text areas detection, and large bitrate allocation detection.

Element 605: The expert judgments unit 605 allows human or AI (artificial intelligence) input for the areas of importance, such as important video segments, important scenes and scene changes, text and texture importance, etc.

Element 606: Coding control 606 is different from coding control 204, since coding control 606 allows inputs from the expert judgments 605 unit. Also, coding control 606 employs adaptive macroblock-based processing as well as frame based processing, rather than the frame-based processing only mode of 204.

It should be noted that coding control 606 handles the I-frame/P-frame selection. I frames, or Key frames, are typically larger in size (in bytes) and of higher importance to overall video quality than P frames. Thus, location, size and timing should be optimized. For example, algorithms which just take each Nth frame in a video sequence and make it into an I frame, will rarely pick an optimal selection. Furthermore, algorithms which “automatically” select I frames based on some criteria and were designed for high bandwidth internet scenarios, will prove non-optimal for the operation of a cellular video call system with much more limited bandwidth. The reason would be that such generic algorithms do not take into account the requirements and limitations of the wireless/video-call medium. Thus, in order to obtain the highest possible quality, it makes sense to have a human (or a specially tailored tool with or without human supervision) select the frames in the clip to be encoded as I frames. Some typical considerations applied in this selection could be:

1. I frames are best located at the beginning and end of a high movement sequence, in order to prevent the “pause” event that I frames generate in a video call due to their relatively much larger size than P-frames (typically 2×-5× the size of P-frames).

2. A single change frame, or a few very high rate change frames, may sometimes be used to create a “splash” effect in a video clip. Such frames are best left out or very highly compressed in a video for the video call medium.

3. Preferential compression—it is possible to apply different compression (or quantization) levels to different parts of an I or P frame. For example, the area of interest (e.g., a human face, or a moving car) might be encoded at better quality than the surrounding background. A human may indicate, to the encoding tool, this division of high/low interest areas. As another example, if the system knows that a certain part of the video contains subtitles (or other information which has to be human readable and is hence critical such as a game score, stock quote, etc.) this area can be compressed with better quality and/or updated more frequently to ensure readability

Element 607: Video output 607 contains a coded video stream for transmission. Unlike video output 205, the output of 607 will have higher visual quality of the important macroblocks.

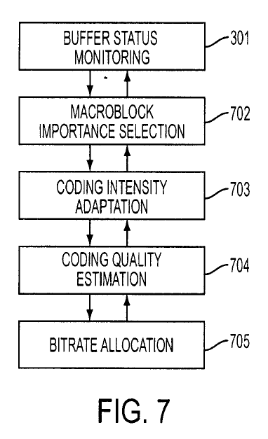

FIG. 7 presents methods which could be executed in the coding control 606 in various exemplary embodiments of the invention. FIG. 7 includes:

Element 301: This is analogous buffer status monitoring as in FIG. 3.

Element 702: Macroblock importance selection 702 is different from frame type selection 302, since in 702 the decision of whether to keep the macroblock or to refresh it is performed on the macroblock level, rather than on the frame level as in 302. For example, if the text does not change and the background changes, only background macroblocks are refreshed. An I-frame is transmitted only if there is a change in many macroblocks.

Element 703: Coding intensity adaptation 703 is different from coding intensity setting 303, since the macroblocks in 703 that have been chosen by expert judgments 605 as relatively important, receive more bitrate allocation than the macroblocks chosen less important. In this sense, the coding intensity is adaptive to macroblock importance.

Element 704: Coding quality estimation 704 is performed per macroblock based on macroblock type and importance, unlike the per-frame estimation in coding quality estimation 304.

Element 705: Bitrate allocation 705 is performed per macroblock, unlike the per-frame allocation in bitrate allocation 305.

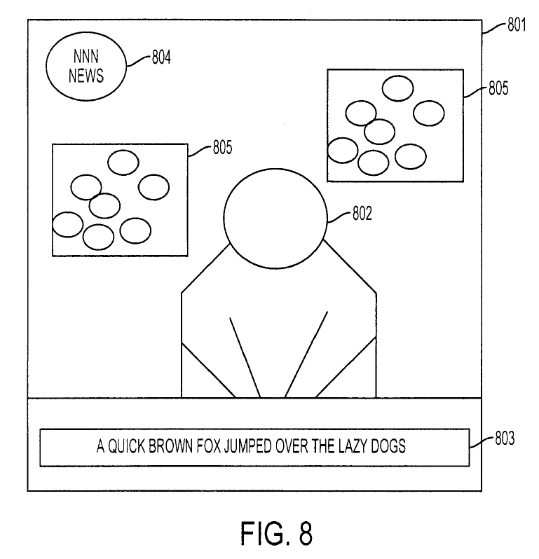

An exemplary embodiment of video layout is presented in FIG. 8.

Element 801: Image frame 801 serves to bound the image and typically does not contain useful information.

Element 802: Talking head 802 typically is important for the user, but does not move much and requires little bitrate.

Element 803: Sliding text-subtitles 803 are important and require a priori known motion of the macroblocks with refresh of one of the macroblocks. Macroblock refresh designates the operation of re-sending the video information of a particular macroblock such that prior information about that macroblock is not required.

Element 804: Company logo 804 is important text, yet it does not move, so it requires little bitrate.

Element 805: Background images 805 are typically not very important, so they may be allocated less bitrate than would be required for higher quality reconstruction.

The proposed exemplary system and methods may provide advantages over the related art, such as:

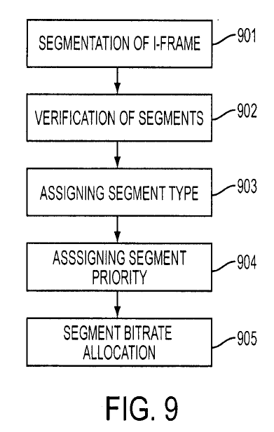

Advantage 1: Using a pre-defined quantization map for frames derived with human/automated input. This pre-defined map can give higher priority to select areas of the video frame (e.g., the subtitles in a movie, the score in a game, the face of the speaker) at the expense of less important areas (e.g., background, areas with a lot of temporal and/or spatial change, etc.). One exemplary flow embodiment for I-frames is depicted in FIG. 9, discussed further below.

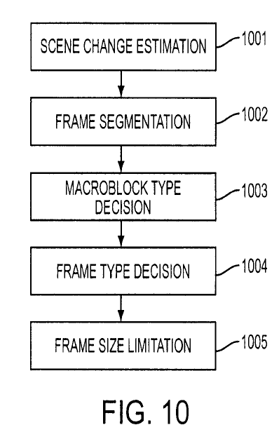

Advantage 2: Constraining I frame size, determining exact location for the I-frames and macroblock refresh, doing the refresh of macroblocks based on importance measure. This is important as typically I frames are much larger than the more prevalent P-frames, and in a video call a single large I frame can cause a noticeable delay in the video flow. Hence it is important to make the I frames as small as possible in size (so as to avoid noticeable delay) and to place them in parts of the video sequence where a delay would be less noticeable—e.g., in the transition between two scenes, in a fixed scene, etc. Similarly, the refresh of macroblocks (which can be considered as a partial I-frame) is best done when the image is not changing quickly. Furthermore, there is little point in doing a macroblock or frame refresh if it is known from the video sequence following the current frame that the block or frame is about to totally change in a few frames. The exemplary flow is depicted in FIG. 10, discussed further below.

One exemplary flow embodiment of using a pre-defined quantization map for frames derived with human or automated input for I-frames is depicted in FIG. 9.

Step 1: Segmentation of I-frame 901 is an automatic process of image segmentation. This may be performed by well known algorithms, such as Gabor wavelet algorithms.

Step 2: Verification of segments 902 is a process of additional segmentation and segment merge based on contextual information, human input, and prior segmentation results.

Step 3: Assigning segment type 903 is a process of segment classification according to movement, synthetic or natural properties, gradients, or texture.

Step 4: Assigning segment priority 904 is a process of grading various segments as more or less important based on contextual information, application, or human input.

Step 5: Segment bitrate allocation 905 implies allocating fixed bitrate to each segment based on the segment's properties and priority.

The total bitrate allocated to the I-frame should not cause image freeze. Transmission time of the frame should be less than the display time of several consecutive frames (typically 1-4 frames, depending on system buffers). As a possible solution for the problem of image freeze, the subtitles area 803 can be given with coarse encoding in the I-frame and then undergo full refresh in the next P-frame.

The exemplary flow embodiment depicted in FIG. 10 considers constraining I frame size, determining exact location for the I-frames and macroblock refresh, and doing the refresh of macroblocks based on importance measure.

Step 1: Scene change estimation 1001 is performed per-macroblock in an image based on motion estimation of three types:

Scene change estimation type 1: Automatic macroblock motion estimation using past and future frames.

Scene change estimation type 2: Motion of a segment (such as a group of macroblocks) in the image can be calculated automatically, based on human input or on a priori data (such as subtitles).

Scene change estimation type 3: Human input of large motion or scene change. Once the changes in the image become too rapid to be handled by partial macroblock refresh procedure, an I-frame is introduced. Otherwise, a P-frame is transmitted with partial macroblock refresh.

Step 2: The I-frame undergoes frame segmentation 1002, as described in FIG. 9. The P-frames segmentation can be recalculated from the I-frames segmentation of the I-frames before and after the P-frame, or calculated from the underlying image. Also, in P-frames the motion information is taken into the account when calculating priorities.

Step 3: Macroblock type decision 1003 is performed per macroblock in the image. The algorithm chooses, based on complexity and priority, one of the following types:

Macroblock type decision criterion 1: High-quality refresh macroblock. These macroblocks are highest-quality macroblocks that require more bit allocation.

Macroblock type decision criterion 2: Low-quality refresh macroblock. These macroblocks are used for low-priority objects refresh.

Macroblock type decision criterion 3: Motion correction macroblock. These macroblocks are used when the motion estimation works adequately, or to improve the visual effect of previously transmitted low-quality macroblocks.

Macroblock type decision criterion 4: Skip macroblocks contain no frequency data and are typically followed by refresh macroblocks in the next frame.

Step 4: Frame type decision 1004 is performed based on the total effect of time between I-frames limitation, scene changes time location, macroblock refresh rate, and other constraints.

Step 5: Frame size limitation 1005 dictates limiting the frame size in case of large I-frames. The remaining data can be transmitted in the following P-frames either via refresh or via motion correction macroblocks.

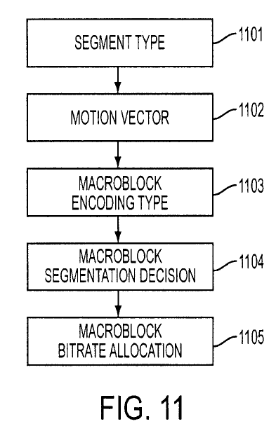

The exemplary flow embodiment depicted in FIG. 11 shows determining quantization level using a priori knowledge, using special quantization for parts with text, and constraining motion vectors using a priori knowledge.

Step 1: Segment type 1101 allows using the information regarding the segment type for macroblock coding. If multiple segments are present in a macroblock, the decision regarding the segment type of the macroblock can be performed automatically and later verified via human input.

Step 2: Motion vector 1102 addresses the issue of multiple motion vectors in single macroblock. Generally the motion vector associated with highly important data, such as subtitles, should be selected, rather than motion vector associated with background. Due to the high probability of false registration inside text and texture areas, this process is typically monitored by human or automatic system.

Step 3: Macroblock encoding type determines the relevant categories for each specific macroblock to be encoded in the frame. Macroblock encoding type can be of various kinds, including, for example, refresh block or motion-compensate block, and high quality or low quality. The macroblock encoding type should be generally associated with most important data in the macroblock, such as news subtitles, game scores, or advertisement brand names.

Step 4: Macroblock segmentation decision 1104 addresses the case of multiple segments in the same macroblock. The decision determining to which segment the macroblock belongs, is based on accurate segmentation of the macroblock. For example, if the macroblock is associated with text when at least 20% of the macroblock area is covered by text, then segmentation of text and background should be performed to determine the text area as a percentage of the macroblock area.

Step 5: Macroblock bitrate allocation 1105 is the final step of bit allocation, and is performed according with frame bit allocation, macroblock priority, macroblock type and dominant segment, and bitrate required by other macroblocks inside the frame.

During the scene change estimation step 1001 there are two special scenarios that are addressed below. The first scenario is fade-in and fade-out, and the second scenario is medium motion scenario.

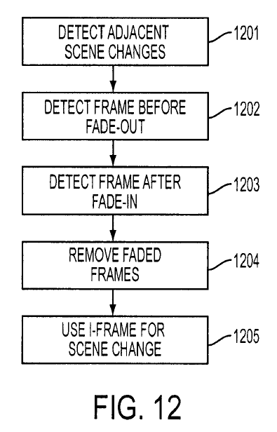

The handling of the fade-in and fade-out scenario is described in FIG. 12. The fade-in and fade-out scenario is a scene change with three scenes, two of which are meaningful. The third scene, positioned between the two meaningful scenes, is not meaningful, that is to say, the third scene is empty. In this case, the intermediate scene, and in fact all of the intermediate empty scenes, may be removed with no or insignificant damage to the movie information. The following steps are used to achieve this end in one exemplary embodiment of the invention:

Step 1: In element 1201, adjacent scene changes are detected to identify the case of fade-in and fade out. Typically at least two significant and adjacent scene changes are detected, but the invention is not limited to this number of such scene changes.

Step 2: In element 1202, frame before fade-out is detected to identify when the fade-out process starts.

Step 3: In element 1203, frame after fade-in is detected due to motion that is non-uniform in comparison to the motion expected in a typical movie scene.

Step 4: In element 1204, faded frames are removed to allow a higher bitrate for I-frame transmission.

Step 5: In element 1205, I-frames are used for scene change, that is, the first frame of the next scene is transmitted as an I-frame.

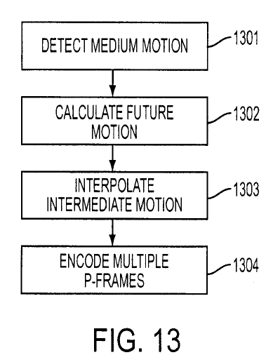

The medium motion scenario is characterized by motion that is not small enough to be encoded in a single P-frame, but is still significantly too small to be encoded in two or three P-frames. In this case, it makes sense to insert additional P-frames into the movie, since the bitrate required for one I-frame can be equivalent to the bitrate of six to eight P-frames. The handling of medium motion scenario is described in one exemplary embodiment of the invention, presented in FIG. 13.

Step 1: In element 1301, medium motion is detected. For example, if the encoding standard supports motion of one pixel for motion macroblock, but motion of three pixels is detected, then medium motion handling is activated in the subsequent steps described below.

Step 2: In element 1302, future motion is calculated, so that the motion can be best distributed among multiple inserted frames.

Step 3: In element 1303, intermediate motion is interpolated so that the intermediate P-frames are created. For example, motion of three pixels is translated into three frames each with single pixel motion.

Step 4: In element 1304, multiple P-frames are encoded, provided their total required bitrate is lower than the bitrate required by an equivalent I-frame (or P-frame with macroblock refresh). Notice that motion is not the only parameter that can be distributed among two or more P-frames, since macroblock changes can also be distributed among frames.

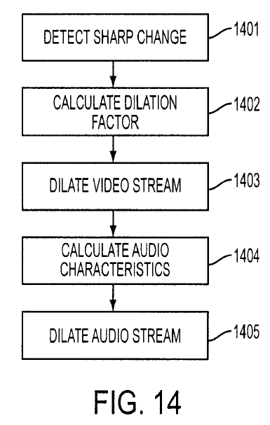

Audiovisual time expansion, according to one exemplary embodiment of the invention, is illustrated in FIG. 14.

Step 1: In element 1401, sharp change in video data is detected. In many video clips, especially fast paced clips with many camera shot angle changes, the clip is just too intensive to be transmitted in a video call—due to the screen size, or the bit rate allowed. The period of sharp motion is typically short, often one second or less, and the boundaries of the sharp motion can be clearly detected.

Step 2: In element 1402, dilation factor for audiovisual data is calculated. The designated period of audio and video from the original clip, typically but not exclusively one second, is encoded into a longer period of time in the transcoded clip. For example, ratios of expansion of 115%-135% are not highly visible or audible to the viewer. In some cases expansion ratios of 150% and higher may be achieved with no noticeable effects.

Step 3: In element 1403, the video stream is dilated. In the video part, the expansion can be accomplished simply by encoding the video into a clip at X frames per second, then transmitting it during the video call at X/R frames per second, with R being the expansion ratio. For example, a movie could be encoded as a 10 fps clip, then streamed at 8 fps, hence being “expanded” by 125%.

Step 4: In element 1404, audio characteristics are calculated. It should be known, or may be calculated, which kind of audio data, i.e., noise or music or voice, is to be dilated, so that a proper dilation mechanism is used. For example some data must preserve pitch, so the required mechanism would be pitch-preserving audio dilation.

Step 5: In element 1405, the audio stream is dilated. In the audio stream, sophisticated processing can be applied, based on audio characteristics. For example, the speech may be “expanded” without changing the pitch of the voice. This can be accomplished with commercially available products, such as, for example, the Sound Forge™ product using the Time Stretch™ mechanism.

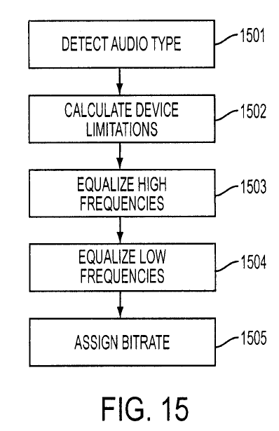

One exemplary embodiment of voice over music processing is illustrated in FIG. 15. Some reasons for dedicated voice over music processing are as follows:

Reason 1: The audio codecs supported by handsets (e.g. GSM AMR-NB supported by 3G H.324M) were designed for speech, and are not optimal for music, or for voice with music in the background.

Reason 2: A handset's speaker system may be too weak, or of inferior quality, making even speech hard to understand during a video call.

Reason 3: Content based audio adaptation is based on the type of the audio information in the clip, and/or on the knowledge of the characteristics of the playback medium (e.g., the type of phone). For example, some phones may have speakers/headsets with particularly inferior response at low audio frequencies. For such phones, it is better to filter out altogether the lower (e.g., 0-200 Hz) frequencies.

One exemplary embodiment for voice over music processing, according to the present invention, is depicted in FIG. 15:

Step 1: In element 1501, audio type is detected. Using time dynamics, voice model, or frequency-based mechanisms, for detecting the type of audio, e.g. speech, music, noise, or combination thereof, the invention will detect the audio type.

Step 2: In element 1502, device limitations are calculated. Typically this stage involves retrieving specific device related limitations from a database containing the device models and the specific codec characteristics, and then deciding which limitations are more severe.

Step 3: In element 1503, high frequencies are equalized. The speech-related information is typically concentrated in the low frequencies of the audio data. The higher frequencies, that is, typically above 4000 Hz, typically contain music and noise. In the presence of voice, it is reasonable to attenuate the high frequencies, so that more bitrate is attributed to the speech information.

Step 4: In element 1504, low frequencies are equalized. The mobile device speakers in low frequencies, typically below 200 Hz, typically provide poor audio qualities. The speech becomes clearer if the lower frequencies are attenuated.

Step 5: In element 1505, a bitrate assignment for the audio stream is assigned. Adaptive bitrate assignment for the audio stream allows better utilization of the available bitrate. The selection is performed based on the audio type, the importance of the information as attributed by the expert, the audio/video bitrate tradeoff, the complexity of the data, and other criteria. For example, noise requires less bitrate than speech, which in turn requires less bitrate than music. However, if the music quality is not important, then the music may be treated as noise.

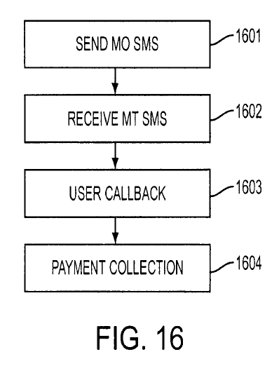

New and superior billing mechanisms, according to one exemplary embodiment of the invention, are illustrated in FIG. 16. In order to present a superior alternative to the premium call rate mechanism, a premium-SMS based method is supported by the exemplary embodiment of the present invention. In this sense, “premium SMS” means an SMS message directed towards a service number rather than a mobile user, where the SMS message carries with it a premium tariff related to the desired service. The following method is one exemplary embodiment:

Step 1: Element 1601 is sending an MO SMS. A user who wishes to subscribe to a video service, or to watch a clip, sends a Mobile Originated (MO) premium SMS to the service number/shortcode.

Step 2: Element 1602 is receiving an MT SMS. After Step 1, the user then receives back a Mobile Terminated (MT) message confirming the subscription/payment, and in that SMS message a phone number is sent to the user.

Step 3: Element 1603 is user callback. After Step 2, the user can open the SMS, and can then make a call to that the SMS number. In most handsets, the call can be made without the user having to key-in that number again.

Step 4: Element 1604 is payment collection. The exemplary embodiment of the invention supports multiple payment mechanisms. Some of the payment mechanisms supported by the exemplary embodiment of the present invention are:

1. One time fee: The user is charged upon the MO SMS or MT SMS, and from then on may use the system by making a video call to the number provided. No further charge will be applied.

2. Time purchase: By sending the premium SMS, the user has paid for X minutes of viewing time, after which a warning message urging the user to purchase more time may be displayed in the video call, and then, if new payment has not been provided, the service or video call is terminated.

3. Pay per clip: This is similar to payment mechanism 2, time purchase, only here the limit is not viewing time but rather the number and/or nature of clips purchased.

4. Mobile terminated (MT) repetition time/clip purchase: This is similar to payment mechanisms 2 and 3, only instead of re-sending more Mobile Originated (MO) premium SMS messages, the user is treated (for billing purposes) as a subscriber and is sent more MT messages used for billing. Each additional message may be sent for a period of time the service is used, or for completion of viewing a clip. For example, after each clip, the user may receive an MT SMS indicating he/she has completed the viewing of one full billable clip.

These billing methods are supported by the fact that the user's handset number is provided to the server through the video call protocol, hence the number can be correlated between the SMS and call management systems. The billing could also be performed via credit card, rather than premium SMS, where the user would enter his or her credit card details over the WEB (or a private information system), along with his or her cellular number. The rest of the transaction would be identical to the procedure described above, with the credit card transaction replacing the MO premium SMS.

The foregoing description of the aspects of the exemplary embodiments of the present invention has been presented for purposes of illustration and description. It is not intended to be exhaustive or to limit the present invention to the precise form disclosed, and modifications and variations are possible in light of the above teachings or may be acquired from practice of the present invention. The principles of the exemplary embodiments of the present invention and their practical applications were described in order to explain and to enable one skilled in the art to utilize the present invention in various embodiments and with various modifications as are suited to the particular use contemplated. Thus, while only certain aspects of the present invention have been specifically described herein, it will be apparent that numerous modifications may be made thereto without departing from the spirit and scope of the present invention.

What is claimed is:

1. A system for distribution of video and audio data, the system comprising:
a wireless device;
a wireless network that communicates to and from the wireless device in an audio video telephony session, and to and from a protocol stack;
wherein the protocol stack interprets the video and audio data that is transmitted to and from the wireless device;
wherein the protocol stack communicates with a dispatcher;
wherein the dispatcher communicates video and audio data to and from the protocol stack, and to and from a storage server;
wherein the storage server stores multiple versions of the video and audio data, wherein each version is suited to work at maximum quality within technical constraints of a particular class of wireless devices; and
a video encoder that employs particular encoding techniques to create the multiple versions, and that communicates the encoded data to the storage server.

2. The system of claim 1, further comprising:
a short message service (SMS) handler that communicates to and from the wireless network, and to and from a provisioning handler;
wherein the provisioning handler maintains a list of users eligible to receive specific audio video services, a plurality of identification codes for each of said users, and a billing status of each of said users; and
wherein the provisioning handler communicates to and from the dispatcher, and to the protocol stack.

3. The system of claim 2, wherein one of the types of identification code maintained by the SMS handler is MSISDN numbers.

4. The system of claim 3, further comprising:
a user requests receipt of a specific service; and
the provisioning handler compares the MSISDN of the user with the list to determine whether the user is eligible for the requested service.

5. The system of claim 3, further comprising:
a user requests receipt of a specific service;
the provisioning handler compares the MSISDN of the user with the list to determine payment status of the user;
if the payment status of the user is acceptable according to previously established criteria, the provisioning handler determines that the user is financially eligible to receive the service; and
if the payment status of the user is not acceptable according to the previously established criteria, the provisioning handler determines that the user is not financially eligible to receive the service.

6. The system of claim 2, wherein one of the types of identification code maintained by the SMS handler is designated shortcode numbers.

7. The system of claim 2, wherein one of the types of identification code maintained by the SMS handler is mobile telephone numbers.

8. The system of claim 2, wherein the provisioning handler communicates with third parties that supply credit card lists or other allowed lists.

9. The system of claim 2, wherein the provisioning handler applies billing logic and causes a warning message to appear on the mobile device when usage of the user is about to exceed the amount of viewing permitted by the billing status of the user.

10. The system of claim 2, wherein the provisioning handler causes the call with the user to terminate when the user has exceeded the amount of viewing permitted by the billing status of the user.

11. The system of claim 2, wherein the provisioning handler provides different callback numbers to different users.

12. The system of claim 11, wherein the provisioning handler uses reply SMS to communicate different callback numbers to different wireless devices.

13. The system of claim 2, wherein the dispatcher creates data packets on the fly.

14. The system of claim 2, wherein the dispatcher uses pre-packetized data which has been encoded to maximize bandwidth given the type of content in the data and the technical limitations of the specific wireless device to which the data will be sent.

15. The system of claim 2, in which the dispatcher decides which version of a data clip to send based on the technical limitations of the specific wireless device to which the clip will be sent.

16. The system of claim 2, wherein the storage server determines the limitations of the specific wireless device by reference to the 3G H.324M technical standard.

17. The system of claim 2, wherein the storage server determines the limitations of the specific wireless device by reference to the IMS/SIP technical protocol.

18. The system of claim 2, wherein the video encoder uses time expansion/dilation techniques to encode the data.

19. The system of claim 2, wherein the video encoder uses content based audio adaptation techniques to encode the data.

20. The system of claim 2, wherein the video encoder uses smart I-frame/P-frame selection techniques to encode the data.

21. The system of claim 20, wherein the system applies different data compression factors to different video data frames to give greater or lesser quality to said frames depending on subject matters of said frames.

22. The system of claim 21, wherein the different data compression factors are applied to a plurality of subject matters selected from the group consisting of a human face, a moving object, and synthetic graphics.

23. The system of claim 20, wherein the system updates different video data frames at different frequencies to give greater or lesser quality to said frames depending on subject matter of said frames.

24. The system of claim 23, wherein the different frequencies of system update are applied to a plurality of subject matters selected from the group consisting of a human face, a moving object, and synthetic graphics.

25. The system of claim 20, wherein the system applies different data compression factors and different frequencies of system of update to different video data frames to give greater or lesser quality to said frames depending on subject matter of said frames.

26. A method for using an encoded video and audio data stream in a wireless communication call to adapt the encoded data stream to optimize mobile radio bandwidth and to optimize technical limitations of a specific wireless device, the method comprising:
determining the specific wireless device to which the encoded data will be sent;
determining the technical limitations of the wireless device to which the data will be sent; and
implementing special encoding techniques to encode the data stream to optimize use of the mobile radio bandwidth and of the technical limitations of the specific wireless device.

27. The method of claim 26, further comprising:
detecting a sharp change in the video data to be sent to the specific wireless device;
calculating an appropriate dilation factor for said video data; and
dilating the video data according to the dilation factor.

28. The method of claim 27, further comprising:
deleting video frames which have very high rates of change and whose deletion will not deter perceived quality of the video data received by the specific wireless device.

29. The method of claim 27, the method further comprising:
slowing the frame rate of video frames which have very high rates of change, wherein said slowing will not deter perceived quality of the video data received by the specific wireless device.

30. The method of claim 27, further comprising:
placing I frames at best locations within high movement sequences of the video data stream to prevent or reduce human perceived pause events.

31. The method claim 27, further comprising:
applying different data compression factors to different data frames to give greater or lesser quality to perception of the video data frames depending on the subject matters of said data frames.

32. The method of claim 31, wherein the different data frames are I frames.

33. The method of claim 31, wherein the different data frames are P frames.

34. The method of claim 26, further comprising:
determining which kinds of audio data must be encoded;
for each kind of audio data to be encoded, calculating characteristics of the audio data so that the audio data is compressed without impacting human perception of the audio data received on and then displayed by the specific wireless device;
calculating an appropriate dilation factor for said audio data; and
dilating the audio data according to the dilation factor.

35. The method of claim 34, in which the pitch of the audio data is not altered to a degree that the alteration would be subject to human perception.

36. The method of claim 26, wherein the encoded data comprises synthetic graphics.

37. A method for allowing users to use premium short message service (SMS) to interact with an audio and video data distribution system, the method comprising:
providing a service number or a short code from a wireless network to a user of a wireless device;
sending a mobile originated (MO) premium SMS text message from the user of the wireless device to the service number or the short code;
receiving by the user, at the wireless device, a mobile terminated (MT) SMS text message confirming payment by the user, wherein the MT SMS text message comprises a phone number;
calling by the user of the wireless device to the phone number to receive a service; and
receiving by the wireless network payment for the service.

38. The method of claim 37, wherein the payment is a one time fee charged to the user of the wireless device.

39. The method of claim 37, wherein the payment is a charge for a specified amount of time during which the user receives the service.

40. The method of claim 39, further comprising:
as the specified amount of time approaches an end, the user receives a warning message requesting the user to purchase additional time;
when the warning message is received, the user purchases the additional time or fails to purchase the additional time;
if the user has purchased the additional time, the wireless network receives an additional payment for the additional time purchased; and
if the user has failed to purchase the additional time, the service terminates at the end of the time originally purchased by the user.

41. The method of claim 37, wherein the payment is in exchange for a plurality of audio or video clips.

42. The method of claim 37, wherein the payment is in exchange for a plurality and quality of audio or video clips.

43. The method of claim 42, wherein the user specifies the plurality and quality of clips that will be received by the wireless device.

44. The method of claim 43, further comprising:
as the specified number of clips of the specified quality approaches an end, the user receives a warning message requesting the user to purchase additional clips of the quality;
when the warning message is received, the user then purchases the additional clips or fails to purchase the additional clips;
if the user has purchased the additional clips, the wireless network receives an additional payment for the additional clips purchased; and
if the user has failed to purchase the additional clips, the service terminates at the end of the number of clips originally purchased by the user.

45. The method of claim 37, further comprising:
payment is based solely on the amount of time the user receives the service;
prior to the user's receipt of the service, the user has committed to payment for the service according to a specific fee schedule;
the amount of time the user may receive the service is a maximum amount of time agreed to by the user prior to receipt of the service, or an unlimited time if no agreement of a maximum time for the receipt of the service is specified; and
the amount of the payment is computed after the user has completed receiving the service.

46. The method of claim 45, further comprising:
prior to the receipt of the service by the user, the user has agreed to pay for the service according to the number of time units received, and according to an agreed definition of the length of each time unit; and
as the user uses each of the time units, the wireless device displays an indication from the wireless network that the service has been used for the respective time unit.

47. The method of claim 46, wherein the indication is a display of an MT SMS received by the wireless device from the wireless network.

48. The method of claim 37, further comprising:
payment is based solely on the number of clip the user receives;
prior to the receipt of the service by the user, the user has committed to payment for clips received according to a specific fee schedule;
the number of clips the user receives is a maximum number agreed to by the user prior to the receipt of the service, or an unlimited number if no agreement of a maximum time number of clips is specified; and
the amount of the payment is computed after the user has completed receiving the number of clips.

49. The method of claim 48, further comprising:
prior to the receipt of the service by the user, the user has agreed to pay for the service according to the number of clips received; and
as the user uses each of the clips, the wireless device displays an indication from the wireless network that the service has been used for the respective clip.

50. The method of claim 49, wherein the indication is a display of an MT SMS received by the wireless device from the wireless network.

51. A method of verifying the status of a user, the method comprising:
sending, by a user, a mobile originated (MO) premium short message service (SMS) from the wireless device to the wireless network requesting a specific service;
routing the MO premium SMS from the wireless network to an SMS handler;
adding, at the SMS handler, MSISDN of the wireless device that sent the MO premium SMS, and routing the MO premium SMS with the MSISDN to the provisioning handler;
comparing, at the provisioning handler, the MSISDN to a known list to determine if the user is eligible to receive the service requested;
if the user is not eligible to receive the requested service, sending, by the provisioning handler via the SMS handler and the wireless network, a mobile terminated (MT) SMS denying user the right to receive the service;
if the user is eligible to receive the requested service, sending from the provisioning handler to the wireless device, an MT SMS with authorization to receive the service, and with a phone number to call or instructions by which the user may access the service; and
after the user receives authorization to receive the service, calling the phone number or executing the instructions for the user to receive the service.

52. The method of claim 51, wherein eligibility is determined by personal status of the user to receive the status by a plurality of criteria.

53. The method of claim 52, wherein one of the criteria to receive the service is age of the user, as determined by the identity of the user associated with the MSISDN.

54. The method of claim 52, wherein one of the criteria is payment status of account associated with the MSISDN.

55. The method of claim 52, further comprising:
the user has previously determined criteria by which content streams are selected for receipt by the user, and said usage criteria have been captured and maintained in the system as a usage characteristic list; and
a dispatcher compares the MSISDN to the usage characteristic list to determine which data stream to send to the user.

56. The method of claim 55, wherein one of the usage criteria is whether the wireless device of the user has received a certain data stream in the past, and if so, not to send the data stream to the user for a specified period of time after last receipt.

57. The method of claim 55, wherein of the usage criteria is whether the wireless device of the user has received a certain data stream in the past, and if so, to continue to send the data stream to the user for a specified period of time after last receipt.

58. The method of claim 55, wherein one of the usage criteria is a specific data stream that the user wants to receive on a default basis, and if so, to send the user the data stream whenever the service is requested unless and until the user provides different instructions.

59. The method of claim 55, wherein one of the usage criteria is video games preferred by the user.

60. The method of claim 55, wherein one of the usage criteria is scores that the user has received on a plurality of video games.

61. The method of claim 55, wherein one of the criteria is that whenever a streaming data stream has been interrupted, the interrupted data stream is sent to the wireless device from a particular point in the data stream, until the entire data stream has been received by the wireless device.
